(19) United States
(12) Patent Application Publication
(10) Pub. No.: US 2023/0052504 A1
(43) Pub. Date: Feb. 16, 2023

(54) HYBRID POWER SYSTEM FOR LAWN ROBOTS

(71) Applicant: TEXAROBA TECHNOLOGY INC., Plana, TX (US)

(72) Inventor: Jia SONG, Tulsa, OK (US)

(73) Assignee: TEXAROBA TECHNOLOGY INC., Plano, TX (US)

(21) Appl. No.: 17/797,191

(22) PCT Filed: Feb. 5, 2021
(86) PCT No.: PCT/US2021/016957

§ 371 Date: Aug. 3, 2022

Related U.S. Application Data
(60) Provisional application No. 62/971,823, filed on Feb. 7, 2020.

(51) Int. Cl. B60L 50/61; A01D 34/00; A01D 34/78; A01D 69/02; B60L 1/00; H01M 10/44

(52) U.S. Cl. CPC B60L 50/61; A01D 34/008; A01D 34/78; A01D 69/02; B60L 1/003; H01M 10/441; A01D 2101/00

(57) ABSTRACT

The present invention relates to a hybrid power system for a robot or a robotic lawn mower. It comprises at least one generator for generating an electric current; at least one control board being provided to receive the electric current from the generator; and at least one rechargeable battery being connected to and charged by the electric current from the control board, and being charged by the electric current from the generator as well. The generator can he an AC generator or a DC generator, and there may be two generators, and two operation control boards. There are two types of end units, such as a cutting assembly and a moving assembly. At least one of the control boards provides a driving power for driving one of the end units of the robot or the robotic lawn mower, which may be operative under AC or DC. The cutting assembly may include a set of cutting tools and the moving assembly may have a set of moving wheels, which may move in any directions under the control of the control boards.

### CROSS-REFERENCE TO RELATED APPLICATIONS

The present application claims priority to U.S. Provisional Patent Application No. 62/971,823, filed on Feb. 7, 2020, the disclosure of which is incorporated herein by reference in its entirety as part of the present application.

### FIELD OF THE INVENTION

The present invention relates to a power or energy system for lawn robots or robotic lawn mowers. More particularly, it relates to a hybrid power system for robotic lawn mowers or the like.

### BACKGROUND OF THE INVENTION

Currently, lawn robots or robotic lawn mowers or any robots use rechargeable batteries as the main or sole power or energy source. When the batteries go low, the robots must recharge the batteries, either by plugging in a power outlet or through a charging station which may be installed near a working site, such as, a lawn. This should work fine if the robots are close to power sources and charging time may be relatively unrestrained as needed; or the charging time will not take long if properly scheduled. In any event, pure battery power may not be an ideal solution for the robots working at remote sites, i.e., far away from any power sources or relatively large sites or lawns, because the capacity of any kinds of batteries is often limited. Therefore, it is desirable to find more feasible approaches than just rechargeable batteries or backup batteries. In any event, a larger capacity of power systems or shorter charging time of batteries or a way of rejuvenating power systems of the lawn robots are in demand for more efficient use of lawn robots of any kind.

Sizes of lawns vary significantly from relatively small lawns or yards of residences or residential areas to relatively large or even huge lawns, such as football fields, public parks, road side areas, golf courses, and so on. In any event, mere battery power may not fulfill all of the needs of mowing relatively bigger lawns or areas, and thus any battery power is definitely limited in view of various situations. Even with packs of backup batteries or installation of charging stations, the change of batteries or charge of batteries will still need lots of time.

### SUMMARY OF THE INVENTION

Hence, a hybrid power system of the present invention comes along and fulfils those needs of mowing bigger lawns or areas without too much hassles.

According to one embodiment of the present invention, a hybrid power system for a robot or a robotic lawn mower comprises at least one generator for generating electricity for charging at least one rechargeable battery whenever the battery needs to be charged, and the battery is provided for powering and driving at least a set of cutting tools and a set of moving wheels of the robot or the robotic lawn mower.

According to another embodiment of the present invention, a hybrid power system for a robot or a robotic lawn mower comprises at least one generator for generating electricity for charging at least one rechargeable battery whenever the battery needs to be charged, and the battery is provided for powering and driving at least a set of cutting tools and a set of moving wheels of the robot or the robotic lawn mower, and the hybrid power system further comprises at least one circuit board for converting the electric current from the generator to a suitable electric current for charging the battery and for controlling the charge of the battery.

According to the other embodiment of the present invention, a hybrid power system for a robot or a robotic lawn mower comprises at least one generator for generating electricity for respectively charging at least two rechargeable batteries whenever the batteries need to be charged, one of the rechargeable batteries being provided for powering and driving a set of cutting tools of the robot or robotic lawn mower and the other of the rechargeable batteries being provided for powering and driving a set of moving wheels of the robot or the robotic lawn mower. The hybrid power system further comprises at least two circuit boards, one of which is for converting the electric current from generator to a suitable electric current for charging the battery and for controlling the charge of the battery for powering and driving the set of cutting tools, and the other of which is for converting the electric current from generator to a suitable electric current for charging the battery and for controlling the charge of the battery for powering and driving the set of moving wheels of the robot or robotic lawn mower.

According to a further embodiment of the present invention, a hybrid power system for a robot or a robotic lawn mower comprises two generators for generating electricity for respectively charging at least two rechargeable batteries whenever the batteries need to be charged, and one of the generators for charging the rechargeable battery or batteries is provided for powering and driving a set of cutting tools of the robot or robotic lawn mower and the other generator for charging the rechargeable battery or batteries is provided for powering and driving a set of moving wheels of the robot or the robotic lawn mower. The hybrid power system further comprises at least two circuit boards, one of which works with one of the generators for converting the electric current from the generator to a suitable charging electric current to the battery and for controlling the charge of the battery for powering and driving the set of cutting tools, and the other of which works with the other generator for converting the electric current from the generator to a suitable charging electric current to the battery and for controlling the charge of the battery for powering and driving the set of moving wheels of the robot or robotic lawn mower.

According to any of the aforesaid embodiments of the present invention, the generator is an AC generator and the circuit board will convert the AC current from the generator to a DC current at a predetermined and fixed voltage through rectification, regulation, and filtering; and the DC current will then be provided to charge the rechargeable battery and to a control board for driving and controlling the cutting tools and moving wheels of the robot or robotic lawn mower.

According to any or some of the aforesaid embodiments of the present invention, the generator is an AC generator and the circuit board converts the AC current from the generator to a DC current at a predetermined and fixed voltage through rectification, regulation, and filtering; and the DC current will then be provided directly to a control board for driving and controlling the cutting tools and moving wheels of the robot or robotic lawn mower.

According to any of the embodiments of the present invention, the generator is an AC generator and the circuit board will convert the AC current from the generator to a DC current tat a fixed and predetermined voltage through rectification, regulation, and filtering, and the DC current will then be provided to charge the rechargeable battery and to a control board for driving and controlling the cutting tools and moving wheels of the robot or robotic lawn mower.

According to the other embodiment of the present invention above, the generator is an AC generator and the AC current is provided respectively to two circuit boards, one of which will convert the AC current from the generator to a DC current at a fixed and/or predetermined voltage through rectification, regulation, and filtering, and then the DC current is provided to charge one of the rechargeable batteries and to one of two control boards for driving and controlling the cutting tools of the robot or robotic lawn mower, and the other of which will convert the AC from the generator to a DC at a fixed and/or predetermined voltage and then the DC current is provided to charge the other of the rechargeable batteries and to the other of two control boards for driving and controlling the moving wheels of the robot or robotic lawn mower.

A further alternative process of electric current from a generator is to provide the AC current to two circuit boards, one of which is for the cutting tools and the other for the moving wheels, and then to provide the AC currents directly to two corresponding control boards, one of which is for the cutting tools and the other for the moving wheels. It means that AC current can also be the direct driving power for the cutting tools and moving wheels.

A still further alternative process of electric current may be from two generators, and the AC current from each of the generators will be provided separately for conversion into respective DC currents to a rechargeable battery for charging the battery and to a control board for driving a motor, and the AC current will also be provided directly to another control board for driving another motor, and the AC current from the other generator will be processed in the same or similar way for driving, i.e., a converted DC for driving a motor and the AC for driving another motor. It is understood that the motors may drive, respectively and independently, the cutting tools or moving wheels.

Moreover, the generator may be a DC generator. The cutting assembly of the cutting tools and the moving assembly of the moving wheels may be driven alternatively by AC instead of DC. Therefore, the circuit board for processing the DC from the generator to either AC or DC for driving the cutting and moving assemblies will be different. These will be described in connection with the accompanying drawings.

### BRIEF DESCRIPTION OF DRAWINGS

FIG. 1 illustrates a configuration of a robotic lawn mower with a single rechargeable battery or a bank of rechargeable batteries at a fixed voltage serving the entire robot.

FIG. 2 shows a basic configuration for a robotic lawn mower with a hybrid power system of a rechargeable battery and a generator, according to the first embodiment of the present invention.

FIG. 3 illustrates an enhanced version or more details of a hybrid power system for a robotic lawn mower, including a circuit board for controllable charging of the batteries with the generator, according to the first embodiment of the present invention.

FIG. 4 illustrates an alternative configuration of a hybrid system for a robotic lawn mower, having one generator to provide controllable charging of two rechargeable batteries in association with two circuit board, according to the second embodiment of the present invention.

FIG. 5 illustrates a further alternative configuration of a hybrid system for a robotic lawn mower, having two generators to provide, respectively, controllable charging of two rechargeable batteries in accordance with the third embodiment of the present invention.

FIG. 6 shows the process of electric current from an AC generator to a DC output for charging the rechargeable battery and/or for driving the respective motors of the cutting and moving assemblies, in accordance with the above first embodiments of the present invention.

FIG. 7 shows the process of electric current from an AC generator split to two DC outputs, respectively, for charging two rechargeable batteries, and driving the respective motors of the cutting assembly and moving assembly, in accordance with the above second embodiment of the present invention.

FIG. 8 shows the process of electric current from an AC generator to an AC output for directly driving the respective motors in accordance with the fourth embodiment of the present invention.

FIG. 9 shows the process of electric current from an AC generator split to two AC outputs for driving, respectively, the motors for the cutting tools and moving wheels, in accordance with the fifth embodiment of the present invention

FIG. 10 illustrates two alternative processes of electric current, one of which shows that the current from an AC generators is split to provide a DC output for driving the cutting assembly and an AC output for driving the moving assembly, respectively; and the other of which shows that the current from an AC generator is split to provide an AC output for driving the cutting assembly and a DC output for driving the moving assembly, as a combination or blended configuration of AC and DC end units, according to the sixth embodiment of the present invention, which is similar to the above second, embodiment of the present invention.

FIG. 11 illustrates the process of electric current from a DC generator to a DC output for charging the rechargeable battery and/or for driving the respective motors of the cutting and moving assemblies, as the seventh embodiment, but similar with the above first embodiments of the present invention, which is AC to DC.

FIG. 12 illustrates the process of electric current from a DC generator split to two DC outputs, respectively, for charging two rechargeable batteries, and for driving the respective motors of the cutting assembly and moving assembly, as the eighth embodiment, but similar with the above second embodiment of the present invention.

FIG. 13 illustrates the process of electric current from a DC generator to an AC output for driving the respective motors of the cutting and moving assemblies, as the ninth embodiments, but similar with the above fourth embodiment of the present invention.

FIG. 14 illustrates the process of electric current from a DC generator split to two AC outputs for driving, respectively, the motors for the cutting tools and moving wheels, as the tenth embodiment but similar with the fifth embodiment of the present invention

FIG. 15 illustrates two alternative processes of electric current, one of which shows that the current from a DC generator is split to provide a DC output for driving the cutting assembly and an AC output for driving the moving assembly, respectively; and the other of which shows that the current from a DC generator is split to provide an AC output for driving the cutting assembly and a DC output for driving the moving assembly, as the eleventh embodiment of the present invention, but similar with the sixth embodiment above.

FIGS. 16 and 17 are further alternatives of FIG. 15, and they adopt, respectively, a DC generator and an AC generator for a hybrid power system, wherein either the current from DC generator is processed and provided directly for driving one of the cutting and moving assemblies, and the current from AC generator is processed and provided for driving the other of the cutting and moving assemblies; or vice versa.

### DETAILED DESCRIPTION OF THE INVENTION

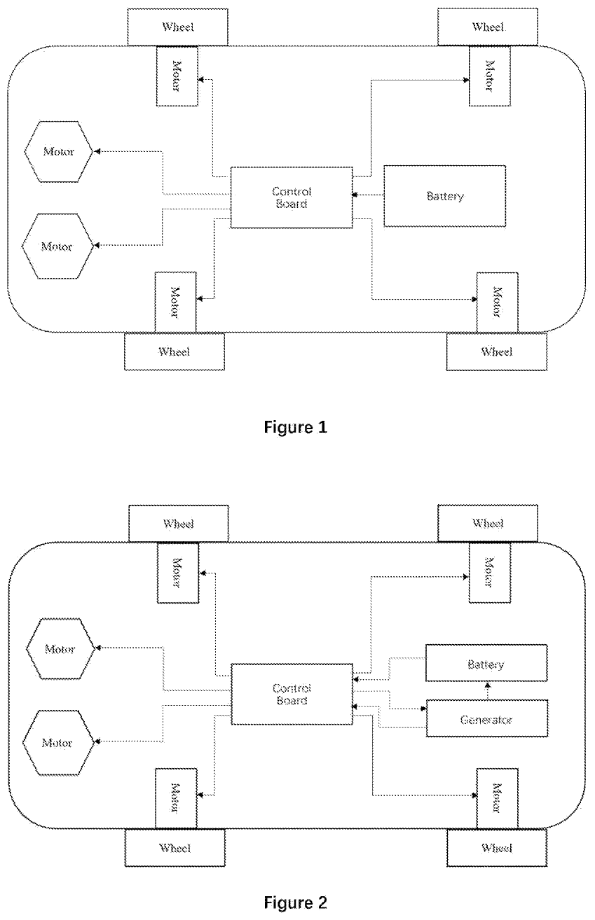

As illustrated in FIG. 1, each of robotic lawn mowers comprises, generally, a cutting assembly of cutting tools, a moving assembly of moving wheels, and respective driving mechanisms for operating the cutting assembly of cutting tools and for operating the moving assembly of moving wheels, as well as a power system providing power so that the robotic lawn mower may move around to get grass cut when the mower passes the lawn. Robotic lawn mowers or any other kinds of robots operate with electricity, and thus the power system of such robots uses normally rechargeable batteries, and the driving mechanisms are normally electric motors. FIG. 1 just illustrates those main components or parts of any robotic lawn mowers, which is illustrative on the basis of a basic model of robotic lawn mower of the same inventor as disclosed in a separate but related patent application.

Electric power system makes the operation of robots simple and efficient. One electric source can operate all parts of a robot, i.e., moving parts and cutting parts at the same time without complicated mechanical structures or design. Just like electric cars driven with simple rechargeable batteries and traditional automobiles driven by combustion engines, lawn mowers may be seen as being driven by electric motors as well as by combustion engines. Then, there are hybrid cars, which has electric driving capacity and combustion engine driving capacity, taking advantages of both. The hybrid power system for robots or robotic lawn mowers in accordance with the present invention differs from the way of hybrid cars, because of much smaller sizes of robots or robotic lawn mowers as compared with any cars. This is because the robots or robotic lawn mowers are directly driven through electric motors by electricity or by rechargeable batteries; while the hybrid cars are driven primarily by combustion engines, and then alternatively driven by electricity through rechargeable batteries at certain times but not always, as auxiliary driving power.

The hybrid power systems of the present invention for robots or robotic lawn mowers are provided with at least one generator in addition to rechargeable batteries. According to the first embodiment of FIG. 2, the very basic hybrid system comprises an electric generator in addition to the rechargeable battery and other components or parts of the robotic lawn mower of FIG. 1. The generator could use gasoline, diesel fuel, kerosene, LNG, propane, and other fuel sources. The generator is used as an additional or auxiliary energy source to produce an electric current, either AC or DC. The electric current is processed to be suitable for charging the rechargeable battery or batteries which in turn provide power for driving respective cutting assembly and moving assembly of the robotic lawn mower, through the respective motors for cutting tools and for moving wheels. The electric current from the generator is used to charge the battery to provide energy or power for moving motors and cutting motors through the control board.

FIG. 2 demonstrates the basic inventive concept of the present invention. There are many different configurations or variations for a hybrid power system in accordance with the present invention. For instance, the cutting assembly and moving assembly may be generally constructed as AC or DC end units, operating at different voltages, amperes, etc. for different applications of the robots or robotic lawn mowers; and the generator or generators may be either an AC generator or DC generator. Hereinafter are the various embodiments of the present invention illustrated and described in details in accordance with the respective drawings.

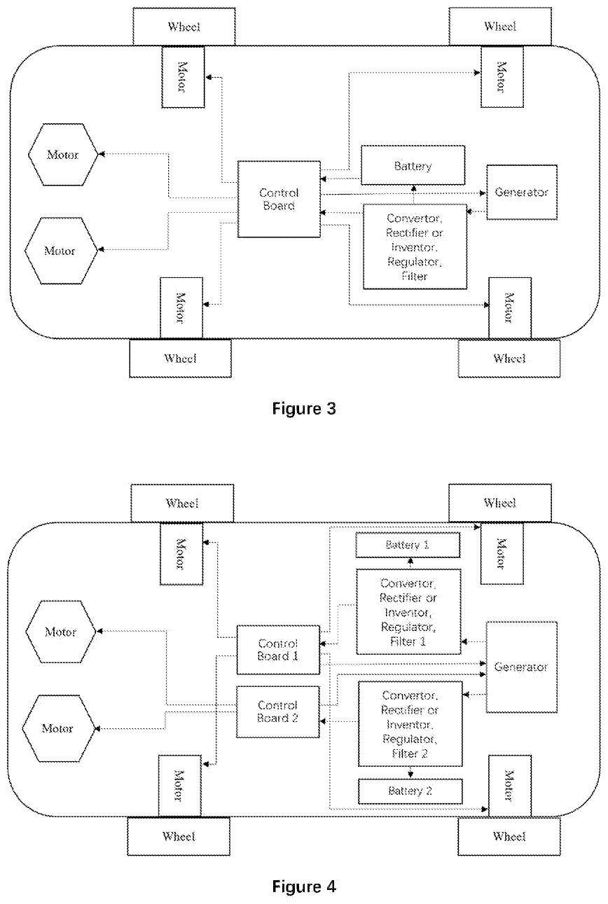

FIG. 3 illustrates more details of the hybrid power system for a robotic lawn mower according to the first embodiment of the present invention. In FIG. 3, a circuit board is provided for controllable charging of the batteries with the generator, and a convertor in the circuit board is used to change the voltage generated from the generator to a desired voltage for the motors and control board. As illustrated in FIG. 3, the generator is an AC generator, and a rectifier is also needed to convert the generated AC (alternating current) to DC (direct current), and then a regulator stabilizes the voltage and a filter is used to smooth the DC current for output to the control board, thereby driving the motors for the cutting assembly and moving assembly.

FIG. 4 illustrates an alternative configuration of the hybrid system for a robotic lawn mower of the second embodiment of the present invention. As seen in FIG. 4, the hybrid power system comprises a AC generator to provide controllable charging of two rechargeable batteries, and thus, there are two circuit boards, each of which includes at least a convertor, a rectifier, a regulator, and a filter for converting the AC from the generator to DC, and two corresponding control boards which may require different voltages respectively for driving the motors of the cutting assembly and the motors of the mowing assembly.

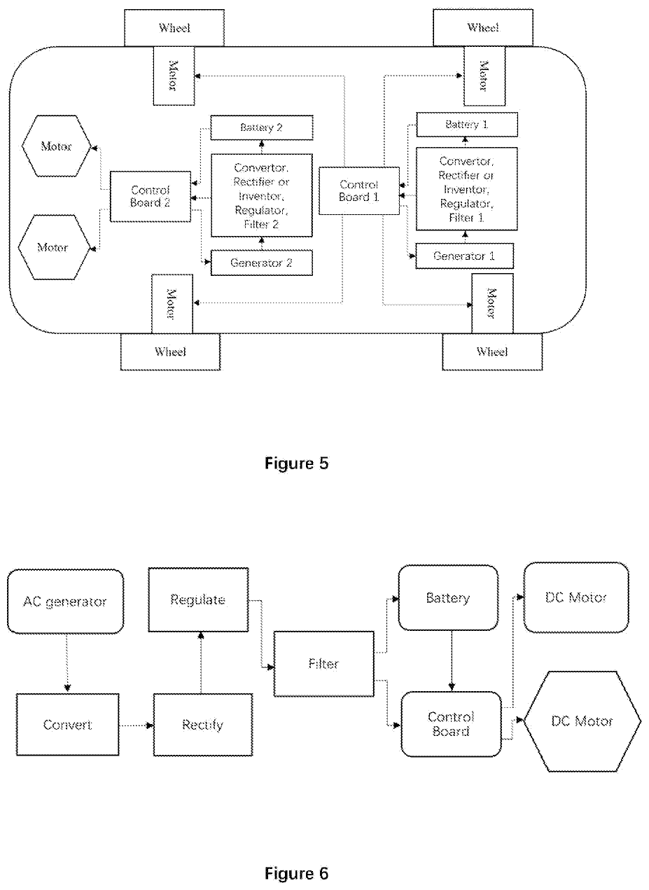

FIG. 5 illustrates a further alternative configuration of the hybrid system for a robotic lawn mower according to the third embodiment of the present invention. In FIG. 5, two generators are provided, instead of just one generator, for controllably charging, respectively, two rechargeable batteries. Basically, it is designed for two independent operated hybrid power sources, one of which provide power to drive the motors of the cutting assembly and the other to drive the motors of the moving assembly of the robot or robotic lawn mower. That is, each generator generates an AC, and connects with a circuit board having at least a convertor, a rectifier, a regulator and a filter for converting the AC to a DC. Each of the circuit boards connects to a corresponding control board, and the control boards may require currents with different voltages in order to provide desired DC outputs, respectively, for driving the cutting assembly and moving assembly.

The followings are descriptions of the respective electric current processes of the aforesaid embodiments of the present invention and more details thereof, as well as further alternative embodiments or variations.

FIG. 6 shows the process of electric current of the first embodiment of the present invention, wherein the current from an AC generator is converted to a DC for charging the rechargeable battery and for driving the motors of the cutting assembly and the moving assembly, respectively. The cutting assembly and the moving assembly are DC powered end units which may be designed to operate, respectively, at predetermined or particular voltages. For example, the AC generator produces alternating electric current, i.e., AC at 110V and the end units may both need DC power 24V. To accomplish the task, the circuit board includes a converter adopted to change the current from AC 110V to AC 24V, and then the electric current AC 24V needs to be rectified to a DC current. Then a regulator is used to automatically maintain the voltage level, and finally, a filter will increase the tolerance of the voltage and make the DC output more stable or smooth. A rechargeable battery is provided as either a main power source or an alternate source of power or energy for driving the motors of the cutting assembly and the motors of the moving assembly. In case the battery is the alternative or auxiliary energy or power source, the DC output of the circuit board is provided, through the control board for the operation mode, to drive directly the cutting and moving assemblies at most of time while charging the battery, which is then a backup or auxiliary energy source for driving the cutting and moving assemblies, whenever the generator does not work or stops working. It can be understood that the rechargeable battery provides driving power to the motors of the cutting and moving assembly primarily, and will be charged by the generator whenever the battery power drops to a threshold.

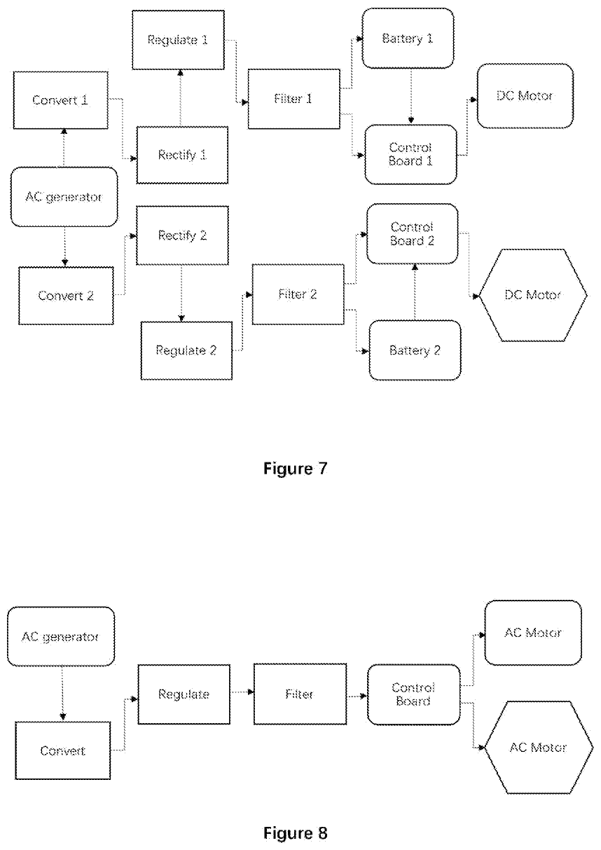

FIG. 7 shows the process of electric current and more detailed structures of the second embodiment of the present invention, wherein the current from an AC generator is split to two circuit boards and then to two corresponding control boards for proving two respective DC current outputs for charging two rechargeable batteries and driving the respective motors of the cutting and moving assemblies. This embodiment may be adopted in the situations where the moving motors and cutting or mowing motors need different voltages and/or different amperes. For example, each of the moving motors may need 24V and 3 A power supply and each of the cutting or mowing motors may need 48V and 10 A power supply.

The alternative embodiment of the hybrid power system of the present invention may fulfill the needs of different voltages and/or different amperes for the respective cutting or mowing motors and the moving motors. That is, two AC generators may be adopted for big or huge size of lawns, which will need much longer time of mowing, and thus the robotic lawn mower should have big capacity and work longer without too much trouble of charging batteries or even adding fuels, and so on. This should be the third embodiment of the present invention as seen in FIG. 5, but the electric current process may be two independent processes, in one of which the current from an AC generator will be converted through the circuit board with at least a convertor, rectifier, regulator and filter to a DC, and the DC is provided to the control board for driving the motors of the cutting or mowing assembly or the other of which is for providing driving power to the motors of the moving assembly. Each of the electric current process will be the same or similar to the one shown in FIG. 6.

FIG. 8 shows the process of electric current and detailed structures of the fourth embodiment of the present invention, wherein the current from an AC generator is processed and provides directly an AC output as a direct driving power to the respective motors of the cutting and moving assemblies. In this configuration of FIG. 8, the current from the AC generator is simply processed with the circuit board having a voltage convertor, a regulator and filer and then the AC is provided to the operation control board which provides the driving power to the AC end units, i.e., the cutting assembly and moving assembly. It can be understood that due to the AC as the operation current, certain protective measures or protective circuits may be necessary for the safety.

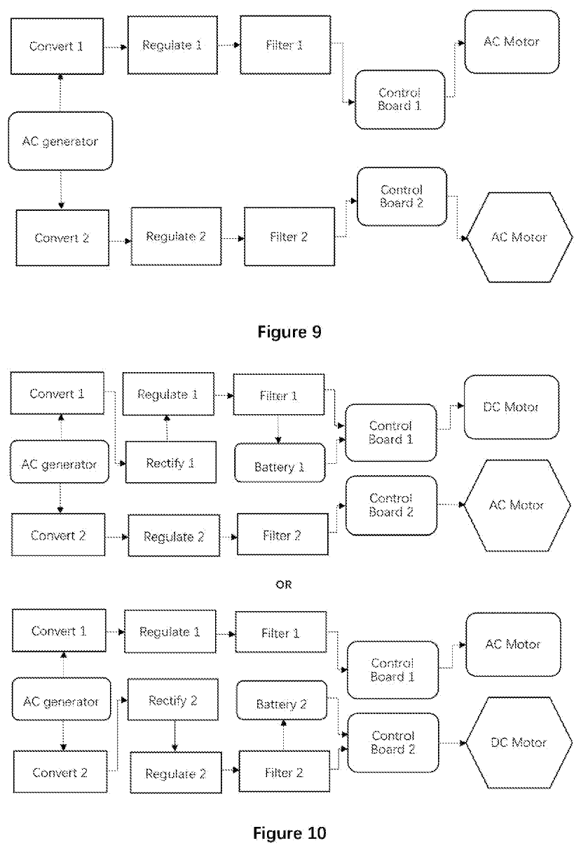

FIG. 9 shows the process of electric current of the fifth embodiment of the present invention. Similar to the fourth embodiment, an AC generator is used, and the current from the AC generator is split to provide two AC outputs for driving, respectively, the motors for the cutting assembly and moving assembly. That is, the current in each route as split from the AC generator is processed with the circuit board having a voltage convertor, a regulator and filer and then the AC is provided to the operation control board which provides the driving power to one of the AC end units, and the other route is to provide the driving power to the other AC end unit, i.e., either the cutting assembly or the moving assembly that operates with AC. However, the motors of the cutting assembly and moving assembly may need to operate at different voltages, as discussed above in connection with the second embodiment of the invention.

FIG. 10 illustrates two further alternative processes of electric current, as the sixth embodiment of the present invention. In the one alternative processes of electric current as seen in FIG. 10, the current from an AC generators is split and processed through a circuit board having a converter, a rectifier, a regulator and a filter to provide a DC output to a control board for driving the cutting assembly and the current from the AC generator as split but still AC is processed by another circuit board having a voltage converter, a regulator and a filter to provide an AC output to another control board for driving the moving assembly. In the other alternative process of electric current as in FIG. 10, the current from an AC generator is split and processed to provide an AC output for driving the cutting assembly and a DC output for driving the moving assembly, as a combination or blended configuration of AC and DC end units, according to the sixth embodiment of the present invention, which is similar to the above second, embodiment of the present invention.

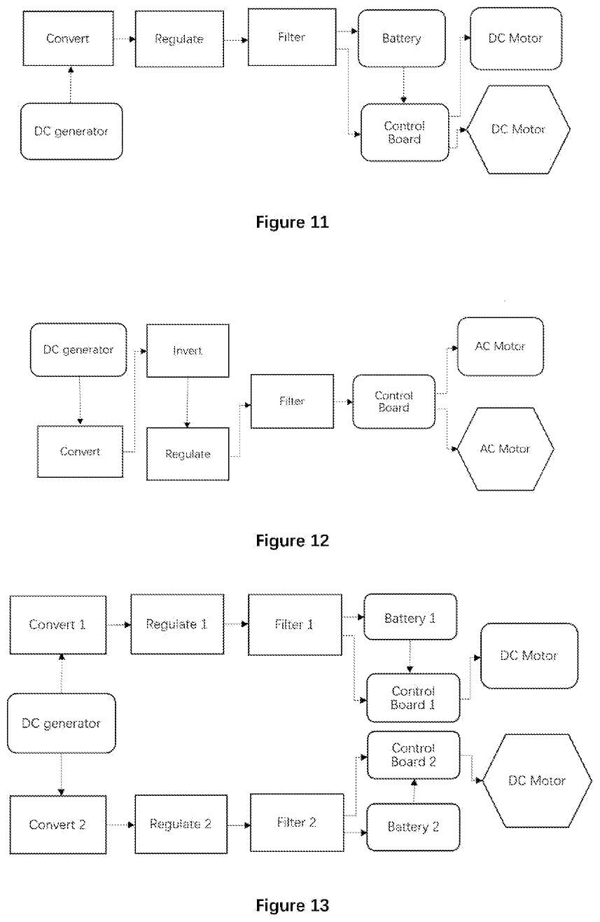

Generally, any current from a generator or generators may not be directly used by operation control boards and/or motors of the end units of the cutting assembly and the moving assembly. Therefore, the current from the generator needs to be processed before being provided to the end units. The aforesaid embodiments illustrate that an AC generator or generators are adopted in the hybrid power systems of robots or robotic lawn mowers; while the end units may be driven either by DC power or AC power as processed through the corresponding circuit boards for converting the voltages and the current to fit different applications as so desired. It can be understood that a DC generator or generators may also be used in the hybrid power systems of the robots or robotic lawn mowers, rather than an AC generator. Hereinafter, the further alternative embodiments of the hybrid power or energy system of the present invention are described in details in connection with FIGS. 11 to 17, which all adopt DC generators.

In case of using DC generator or generators, the current from the DC generator may still need to be processed to be suitable for a DC end unit, and must be processed for applying to an AC end unit.

FIG. 11 illustrates the seventh embodiment of the present invention, which is similar with the above first embodiment, but adopts a DC generator. In this embodiment, the process of electric current is from the DC generator to circuit board for processing the current through converter, regulator, and filter to a suitable DC current at the predetermined voltage for the operation control board to provide a DC output for driving the respective motors of the cutting and moving assemblies; and to provide the processed current to the rechargeable battery for charging the battery.

FIG. 12 illustrates the eighth embodiment of the present invention, which is similar with the above second embodiment, but adopts a DC generator. In this embodiment, the process of electric current is from the DC generator split to routes of current process for providing two DC outputs, respectively, for charging two rechargeable batteries, and for driving the respective motors of the cutting assembly and moving assembly. That is, each circuit board as a route of current process includes at least a converter, a regulator, and a filter, and then the processed current is used for charging the battery and is connected to the control board to provide driving power to the motors of either of the cutting assembly and moving assembly; and the other route is provided to drive the motors of the other of the cutting assembly and moving assembly. Similar to the second embodiment, this design is suitable of the end units that would require different voltages

FIG. 13 illustrates the ninth embodiment of the present invention, which is similar with the above fourth embodiment, but adopts a DC generator, while the end units are powered by AC. Therefore, in this embodiment, the electric current generated from the DC generator shall be first processed to an AC through the circuit board having a convertor, an inverter, regulator and filter before being connected to the control board for providing a suitable AC output to drive the AC end units, i.e., for driving the motors of the cutting and moving assemblies.

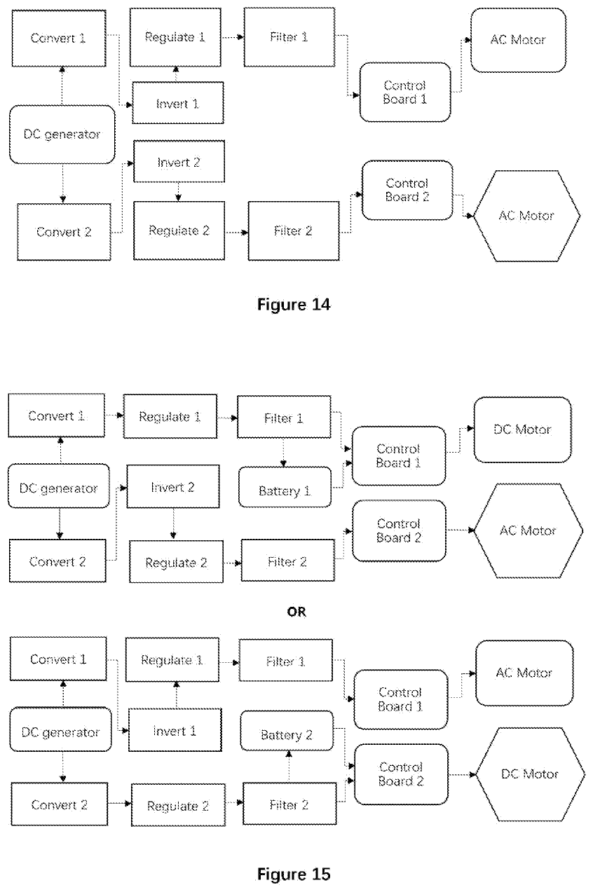

FIG. 14 illustrates the tenth embodiment of the present invention, which is similar with the above fifth embodiment, but adopts a DC generator. In this embodiment, the electric current from the DC generator is split and provided to two circuit boards, each having a converter, an inverter, regulator and filter for providing the processed AC to a control board. One of the control board provides an AC output for driving the motors for the cutting assembly and the other of the control board provides anther AC output for driving the motors of the moving assembly. This is suitable for the end units that would require the operation power at different voltages.

FIG. 15 illustrates the eleventh embodiment of the present invention, which is similar with the sixth embodiment above, that is, two alternative processes of electric current are illustrated. One of the two processes shows that the current from a DC generator is split to provide a DC output for driving the cutting assembly and an AC output for driving the moving assembly, respectively; and the other of the two processes shows that the current from a DC generator is split to provide an AC output for driving the cutting assembly and a DC output for driving the moving assembly.

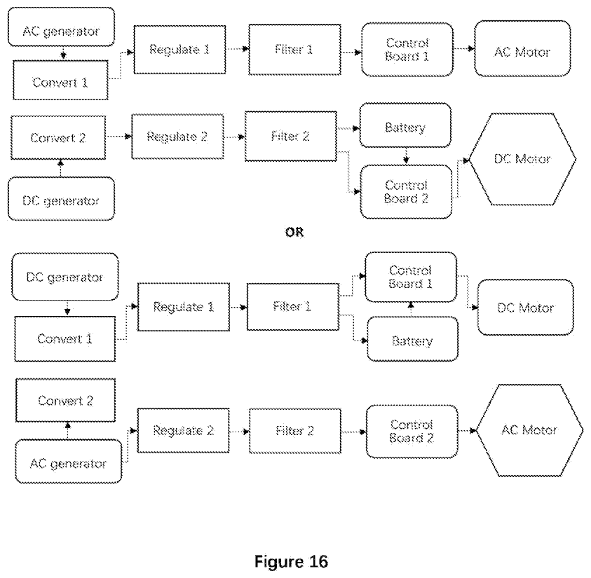

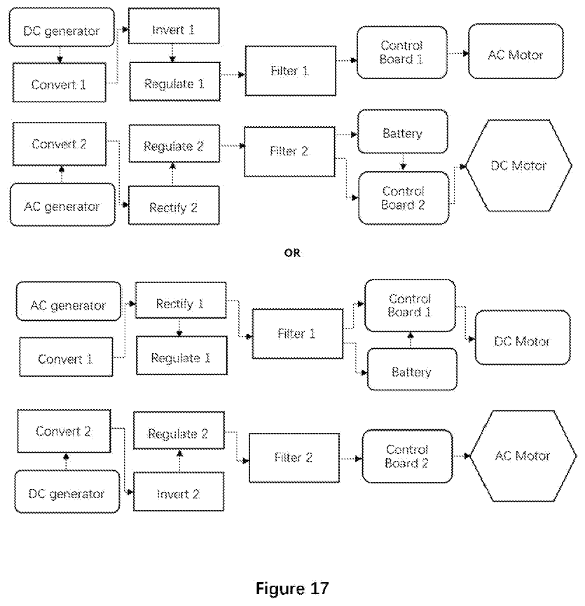

Likewise, FIGS. 16 and 17 are further alternatives of FIG. 15, and they all adopt, respectively, a DC generator and an AC generator for a hybrid power system. However, the hybrid power system of FIG. 16 is different from the one of FIG. 15. The AC current from the AC generator is processed and provided directly for driving one of the cutting and moving assemblies; and the DC current from the DC generator is processed and provided for driving the other of the cutting and moving assemblies; or vice versa, as seen in FIG. 16.

The hybrid power system of FIG. 17 is different from the ones of FIG. 15 and FIG. 16. The AC current from the AC generator is processed into a DC output and then provided to the control board or driving one of the cutting and moving assemblies; and the DC current from the DC generator is processed to a AC output and then provided for driving the other of the cutting and moving assemblies; or vice versa.

Hereinabove, many variations of the hybrid power system of the present invention have been described and the essences of the present invention are defined in the following accompanying claims.

1. A hybrid power system for a robot or a robotic lawn mower, comprising: (1) at least one generator for generating an electric current; (2) at least one control board being provided to receive the electric current from the generator; and (3) at least one rechargeable battery being connected to and charged by the electric current from the control board, and being charged by the electric current from the generator as well; wherein either the control board provides a driving power for driving at least one of end units of the robot or the robotic lawn mower, said end units being at least a cutting assembly having at least a set of cutting tools and a moving assembly having a set of moving wheels.

2. The hybrid power system according to claim 1, further comprising at least one process circuit board being provided between the generator and the control board for converting the electric current from the generator to a processed current of a predetermined voltage to the control board for providing a power to drive the cutting assembly and the moving assembly, and the processed current being connected to the rechargeable battery for charging the battery.

3. The hybrid power system according to claim 2, wherein said at least one generator is an AC generator, and the AC current from the generator is connected to said process circuit board for converting the current from the generator to a processed DC current of the predetermined voltage, and the processed DC is provided to the control board for providing the power to drive respective motors of the cutting assembly and the moving assembly, and provided to the rechargeable battery for battery charging.

4. The hybrid power system according to claim 2, wherein said at least one generator is an AC generator, and the AC current from the generator is split and provided to two process circuit boards and then to two control board, respectively, one of said circuit board converting the current to a processed DC current of a predetermined voltage to the rechargeable battery for battery charging, and to one of said control boards for driving one of said cutting assembly and the moving assembly; and the other circuit board converting the AC current to another processed DC current at another predetermined voltage to another rechargeable battery for battery charging and to the other control board for driving the other of said cutting assembly and moving assembly.

5. The hybrid power system according to claim 2, wherein there are two AC generators, two process circuit boards, two control boards, and two rechargeable batteries, and wherein the AC current from one of the generators is connected to one of the process circuit boards for converting the AC current to a processed DC current at a predetermined voltage to be provided to one of the rechargeable batteries for battery charging and provided to one of the control boards for providing the power to drive one of said cutting assembly and moving assembly; and wherein the current from the other one of the generators is connected to the other one of the process circuit boards for converting the AC current to another processed DC current at another predetermined voltage to be provided to the other one of the rechargeable batteries for battery charging and to the other one of the control boards for providing the power to drive the other of said cutting assembly and moving assembly.

6. The hybrid power system according to claim 1, wherein said at least one generator is an AC generator, and the current from said generator is provided to a circuit board for converting the current to an AC current at a predetermined voltage to be provided to said at least one control board for providing power to drive said cutting assembly and moving assembly.

7. The hybrid power system according to claim 1, wherein said at least one generator is an AC generator, and the current from said generator is spit and provided to two process circuit boards and then to two control board, respectively, one of said circuit board converting the current to a processed AC current of a predetermined voltage to be provided to one of said control boards for driving one of said cutting assembly and the moving assembly; and the other circuit board converting the AC current to another processed AC current at another predetermined voltage to the other control board for driving the other of said cutting assembly and moving assembly.

8. The hybrid power system according to claim 1, wherein said at least one generator is an AC generator, and the current from said generator is spit and provided to two process circuit boards and then to two control board, respectively, one of said circuit board converting the current to a processed AC current of a predetermined voltage to be provided to one of said control boards for driving one of said cutting assembly and the moving assembly; and the other circuit board converting the AC current to a processed DC current at another predetermined voltage, said DC current being provided to the other control board for driving the other of said cutting assembly and moving assembly, and provided to said at least one rechargeable battery for battery charging.

9. The hybrid power system according to claim 2, wherein said at least one generator is a DC generator, and the current from the generator is connected to said process circuit board for converting the current from the generator to a processed DC current of the predetermined voltage, and the processed DC is provided to the control board for providing the power to drive respective motors of the cutting assembly and the moving assembly, and provided to the rechargeable battery for battery charging.

10. The hybrid power system according to claim 2, wherein said at least one generator is a DC generator, and there are two process circuit boards, two control boards, and two rechargeable batteries, and wherein the current from the generator is split and provided, respectively, to said two process circuit boards, one of said circuit board converting the DC current from the DC generator to a processed DC current of a predetermined voltage to one of said rechargeable batteries for battery charging, and to one of said control boards for driving one of said cutting assembly and the moving assembly; and the other circuit board converting the current to a processed DC current at another predetermined voltage to the other of said rechargeable batteries for battery charging and to the other control board for driving the other of said cutting assembly and moving assembly.

11. The hybrid power system according to claim 2, wherein said at least one generator is a DC generator, and the current from the generator is connected to said process circuit board for converting the current from the generator to a processed AC current of the predetermined voltage, and the processed AC is provided to the control board for providing the power to drive respective motors of the cutting assembly and the moving assembly.

12. The hybrid power system according to claim 2, wherein said at least one generator is a DC generator, and there are two process circuit boards and two control boards, and wherein the DC current from the generator is split and provided, respectively, to said two process circuit boards, one of said circuit board converting the DC current from the generator to a processed AC current of a predetermined voltage to one of said control boards for driving one of said cutting assembly and the moving assembly; and the other circuit board converting the current to a processed AC current at another predetermined voltage to the other control board for driving the other of said cutting assembly and moving assembly.

13. The hybrid power system according to claim 1, wherein said at least one generator is a DC generator, and the current from said generator is spit and provided to two process circuit boards and then to two control board, respectively, one of said circuit board converting the current to a processed AC current of a predetermined voltage to be provided to one of said control boards for driving one of said cutting assembly and the moving assembly; and the other circuit board converting the DC current to a processed DC current at another predetermined voltage, said DC current being provided to the other control board for driving the other of said cutting assembly and moving assembly, and provided to said at least one rechargeable battery for battery charging.

14. The hybrid power system according to claim 1, wherein said at least one generator includes an AC generator and a DC generator, and there are two circuit boards, of which are an AD circuit board and a DC circuit board, and two control boards, and wherein the current from said AC generator is provided to the AC process circuit board and then to one of said two control boards, said AC circuit board converting the current to a processed AC current of a predetermined voltage to be provided to one of said control boards for driving one of said cutting assembly and the moving assembly; and the current from said DC generator is provided to the DC circuit board for converting the current to a processed DC current at another predetermined voltage, said DC current being provided to the other control board for driving the other of said cutting assembly and moving assembly, and provided to said at least one rechargeable battery for battery charging.

15. The hybrid power system according to claim 1, wherein said at least one generator includes an AC generator and a DC generator, and there are two circuit boards, of which are an AD circuit board and a DC circuit board, and two control boards, and wherein the current from said DC generator is provided to the DC process circuit board and then to one of said two control boards, said DC circuit board converting the current to a processed AC current of a predetermined voltage to be provided to one of said control boards for driving one of said cutting assembly and the moving assembly; and the current from said AC generator is provided to the AC circuit board for converting the current to a processed DC current at another predetermined voltage, said processed DC current being provided to the other control board for driving the other of said cutting assembly and moving assembly, and provided to said at least one rechargeable battery for battery charging.
